(19) United States
(12) Patent Application Publication
(10) Pub. No.: US 2001/0023411 A1
(43) Pub. Date: Sep. 20, 2001

(54) Method for acquiring electronic data using a data medium, and corresponding data medium

(76) Inventor: Christine Born, Ottobrunn (DE)

Correspondence Address: LERNER AND GREENBERG, P.A., Post Office Box 2480, Hollywood, FL, 33022-2480, US

(21) Appl. No.: 09/794,661

(22) Filed: Feb. 27, 2001

Related U.S. Application Data
(63) Continuation of application No. PCT/DE99/02570, filed on Aug. 17, 1999.

(30) Foreign Application Priority Data
Aug. 27, 1998 (DE) 198 39 099.8

(51) Int. Cl. G06F 17/60

(52) U.S. Cl. 705/26

(57) ABSTRACT

A method for acquiring electronic data and a data medium forming an electronic shopping cart include a processing unit and a data memory connected to a charging device. Preferably, the medium is a smart card. Information relating to a payment operation to be performed in connection with data acquisition is transferred between the processing unit and the charging device, resulting in a payment of a purchase price for the acquired data. The data medium is also connected to an external data memory for storing the acquired data. The data that is to be acquired is transferred from the external data memory to the data medium and is stored in the data memory. Preferably, the memory is integrated and has a capacity of at least 1 MByte. The data medium combines a payment function and the function of a bulk memory for the electronic data that has been acquired.

### CROSS-REFERENCE TO RELATED APPLICATION

This application is a continuation of copending International Application No. PCT/DE99/02570, filed Aug. 17, 1999, which designated the United States.

### BACKGROUND OF THE INVENTION

1. Field of the Invention

The invention relates to a method for acquiring electronic data using a data medium, and also to a corresponding data medium.

European Patent Application 0 681 298 A2 describes a writable data medium having digital data from a computer memory written to it at a sales point. The data medium contains a programmable flash memory for storing the data. The stored digital data are computer games, which can also be erased again, so that a new computer game can be stored on the data medium.

In addition, prior art data media are used for performing payment transactions. For example, card-like data media having magnetic strips or memory chips as the storage medium are widely used. The latter, in particular, are increasingly being used as electronic purses or as credit cards.

To date, purchases of goods using electronic payment have been carried out by a payment transaction and, in addition to the transaction, transfer of the acquired goods. The process also applies to the aforementioned acquisition of electronic data. Thus, the purchase price for the electronic data that are to be acquired in European Patent Application 0 681 298 A2 can be paid, for example, by a cash payment or by using an electronic purse or a credit card.

2. Summary of the Invention

It is accordingly an object of the invention to provide a method for acquiring electronic data using a data medium, and corresponding data medium, that overcomes the hereinafore-mentioned disadvantages of the heretofore-known devices and methods of this general type and that performs the associated payment operation with only little technical involvement.

With the foregoing and other objects in view, there is provided, in accordance with the invention, method for acquiring electronic data, including the steps of connecting a data medium having a processing unit and a data memory to a charging device, transferring information relating to a payment operation to be performed in connection with an acquisition of data between the processing unit of the data medium and the charging device, and paying a purchase price for the data to be acquired as a result of the information transfer, connecting the data medium to an external data memory in which is stored the data to be acquired; and transferring the data from the external data memory to the data medium, and storing the data in the data memory of the data medium.

The method according to the invention is carried out using a data medium having a processing unit and a data memory. The data memory is connected to a charging device, and information relating to a payment operation that is to be performed in connection with the acquisition of the electronic data is transferred between the processing unit of the data medium and the charging device, resulting in the payment of the purchase price for the data to be acquired. In addition, the data medium is connected to an external data memory in which the data to be acquired are stored. The data are transferred from the external data memory to the data medium and are stored in the latter's data memory.

In accordance with another mode of the invention, the data medium is connected to a mobile telephone, and the connection between the data medium and at least one of the charging device and the external data memory is established through the mobile telephone and a mobile radio network.

With the objects of the invention in view, there is also provided a data medium forming an electronic shopping cart, including a processing unit for performing an electronic payment operation, a first data memory for storing information required by the processing unit for performing the electronic payment operation, the first data memory connected to the processing unit, and a second data memory for storing data acquired by the processing unit when the processing unit performs the electronic payment operation.

The data medium according to the invention serves the purpose of an electronic shopping cart and has a processing unit for performing an electronic payment operation using the data medium, a first data memory for storing information that the processing unit requires for performing a payment operation, and also a writable second data memory for storing data that have been acquired by a payment operation performed by the processing unit.

Thus, the invention provides for the payment operation to be carried out and for the acquired data to be stored using a single data medium. Previously, it was customary to provide different data media for the payment operation and for storing the data. Hence, the invention results in a reduced hardware requirement for carrying out the same tasks.

The data medium can, for example, have the function of an electronic purse. The payment operation is then performed by reducing value units stored in the first data memory. Alternatively, the data medium can have a credit card function. For the processing unit to perform the payment operation, a credit card number stored in the first data memory is then output through an output of the data medium during the payment operation.

It is of particular benefit if the data medium is a smart card, and its second data memory is an integrated memory having a memory capacity of at least one megabyte. The memory may then be a flash memory, for example. Previous smart cards having a payment function have no kind of data memory for storing acquired data. The data memories provided to date on such smart cards are used merely to store very small quantities of data and have a correspondingly low memory capacity because they only have to store data required for performing the payment operation. The memories are, for example, the value units in the case of electronic purses, or the credit card number in the case of electronic credit cards. The electronic data to be acquired may be audio and/or video data, for example. Such data generally require a memory capacity of at least one megabyte.

Other features that are considered as characteristic for the invention are set forth in the appended claims.

Although the invention is illustrated and described herein as embodied in a method for acquiring electronic data using a data medium, and corresponding data medium, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a block circuit diagram of a data medium according to the invention; and

FIG. 2 is a diagrammatic illustration of second embodiment of FIG. 1 connected with a mobile radio network.

### DESCRIPTION OF PREFERRED EMBODIMENTS

In all the figures of the drawing, sub-features and integral parts that correspond to one another bear the same reference symbol in each case.

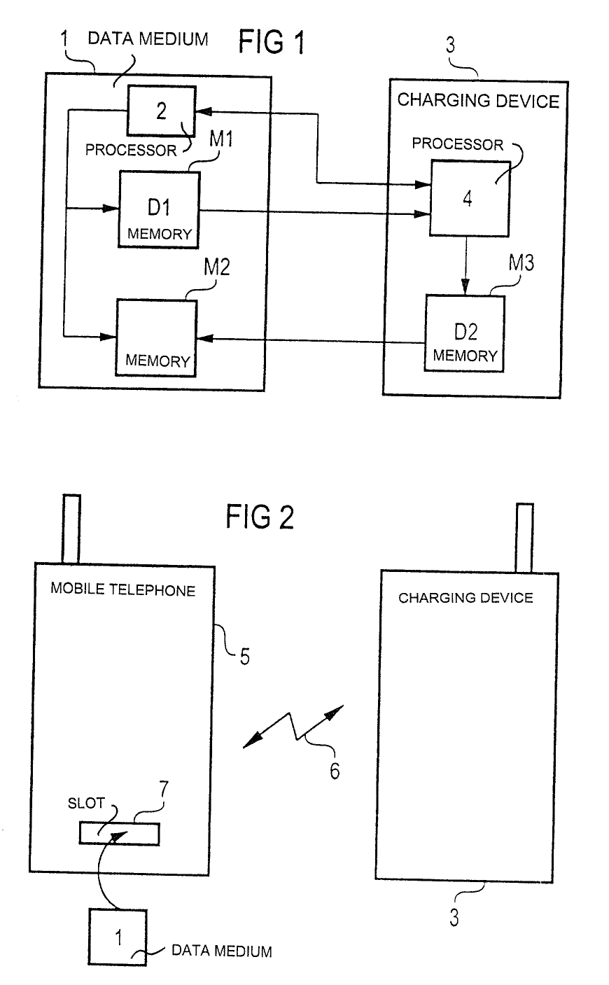

Referring now to the figures of the drawings in detail and first, particularly to FIG. 1 thereof, there is shown a processing unit 2 for performing an electronic payment operation using a data medium 1. The first data memory M1 is used for storing information D1 that the processing unit 2 requires for performing a payment operation. The second data memory M2 is writable and is used for storing data D2 that has been acquired by a payment operation performed by the processing unit 2. The data medium 1 serves the purpose of an electronic shopping cart, that is to say, the acquired data D2 is stored on it, namely in its second data memory M2.

The illustrative embodiment in FIG. 1 shows that the electronic data D2 is acquired by connecting the data medium 1 to a charging device 3 located in a department store. In such a case, the connection between the data medium 1 and the charging device 3 may be contactless using appropriate transmission devices or may involve contact, by inserting the data medium 1 into an appropriate receptacle on the charging device 3.

The charging device 3 likewise has a processing unit 4 and also an external data memory M3. The external data memory M3 stores the electronic data D2 that is to be acquired. The electronic data D2 is purchased by first performing the payment operation, and then by transferring the data D2 from the external data memory M3 of the charging device 3 to the second data memory M2 of the data medium 1. The data D2 is preferably not transferred until after the payment operation has been performed. The payment operation is performed by communication between the processing unit 2 of the data medium 1 and the processing unit 4 of the charging device 3. In such a context, the processing unit 2 of the data medium 1 uses the data D1 that is stored in the first data memory M1. In a first embodiment of the data medium, the data medium has the function of an electronic purse. Then, the data D1 stored in the first data memory M1 are value units corresponding to a sum of money. The processing unit 4 of the charging device 3 conveys the purchase price for the electronic data D2 that is to be acquired to the processing unit 2 of the data medium 1. The processing unit 2 of the data medium 1 then reduces the value units stored in the first data memory M1 by a corresponding amount and possibly returns an appropriate acknowledgement signal to the charging device 3.

In a second embodiment of the data medium 1, the data medium has the function of an electronic credit card. As such, the data D1 stored in its first data memory M1 contain a credit card number. To perform the payment operation, the processing unit 2 of the data medium 1 conveys the credit card number to the processing unit 4 of the charging device 3.

FIG. 2 shows a second illustrative embodiment of the invention, in which a mobile radio network 6 connects the data medium 1, which is again a smart card, and the charging device 3. The data medium 1 is inserted into a receiving slot 7 on a mobile telephone 5. An order for the desired electronic data D2 is then placed through the mobile telephone 5. The order is transmitted to the charging device 3. Subsequently, the payment operation is performed and the electronic data D2 to be acquired are transmitted over the mobile radio network 6 in the manner already described with reference to FIG. 1.

The illustrative embodiment in FIG. 2 allows payment and the acquisition of electronic data over any distances. In addition to the payment function and to the function of a data memory for the acquired electronic data D2, the data medium 1 in the illustrative embodiment shown in FIG. 2 may also have an authorization function for the use of the mobile telephone or of the mobile radio network 6. Such authorization requires a further data memory on the data medium 1, which stores an appropriate authorization code. Then, the data medium 1 additionally combines the function of the SIM cards customary to date for the operation of mobile telephones with its functions that have already been explained.

Once the electronic data D2 has been acquired by storing it in the second data memory M2, the electronic data D2 can easily be transported by inserting the data medium 1 into appropriate reading units.

Instead of acquiring the data D2 locally using a mobile telephone, as explained with the aid of FIG. 2, the data could also be acquired using a computer that can be connected to the data medium 1. The computer is connected to the charging device 3 over the Internet, for example.

I claim:

1. A method for acquiring electronic data, which comprises:
connecting a data medium having a processing unit and a data memory to a charging device;
transferring information relating to a payment operation to be performed in connection with an acquisition of data between the processing unit of the data medium and the charging device, and paying a purchase price for the data to be acquired as a result of the information transfer;
connecting the data medium to an external data memory in which is stored the data to be acquired; and
transferring the data from the external data memory to the data medium, and storing the data in the data memory of the data medium.

2. The method according to claim 1, which further comprises:
connecting the data medium to a mobile telephone; and
establishing the connection between the data medium and at least one of the charging device and the external data memory through the mobile telephone and a mobile radio network.

3. A data medium forming an electronic shopping cart, comprising:
a processing unit for performing an electronic payment operation;
a first data memory for storing information required by said processing unit for performing the electronic payment operation, said first data memory connected to said processing unit; and
a second data memory for storing data acquired by said processing unit when said processing unit performs the electronic payment operation.

4. The data medium according to claim 3, wherein said first data memory stores value units to be reduced when said processing unit performs the electronic payment operation.

5. The data medium according to claim 3, wherein said first data memory stores a credit card number to be output by said processing unit during the electronic payment operation.

6. A smart card forming an electronic shopping cart, comprising:
a processing unit for performing an electronic payment operation;
a first data memory for storing information required by said processing unit for performing the electronic payment operation, said first data memory connected to said processing unit; and
an integrated memory for storing data acquired by said processing unit when said processing unit performs the electronic payment operation, said integrated memory having a memory capacity of at least 1 MByte.

7. The data medium according to claim 6( wherein said first data memory stores value units to be reduced when said processing unit performs the electronic payment operation.

8. The data medium according to claim 6, wherein said first data memory stores a credit card number to be output by said processing unit during the electronic payment operation.
